(19) United States
(12) Patent Application Publication
(10) Pub. No.: US 2005/0002081 A1
(43) Pub. Date: Jan. 6, 2005

(54) Functional safety glazing unit

(76) Inventors: Fabien Beteille, Revel (FR); Jean-Marc Boucheret, Caluire Et Cuire (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/488,099

(22) PCT Filed: Aug. 21, 2002
(86) PCT No.: PCT/FR02/02913

(30) Foreign Application Priority Data
Sep. 14, 2001 (FR) 01/11902

(51) Int. Cl. G02F 1/153

(52) U.S. Cl. 359/275; 428/911; 359/288; 349/182

(57) ABSTRACT

A functional safety glazing unit successively including: a first rigid substrate, a second rigid substrate, a third rigid, semi-rigid or flexible substrate, and at least one active system including at least one layer and placed between the first and second substrates or between the second and third substrates. The third substrate is set back with respect to the other two substrates. Further, at least one polymer film having the function of retaining splinters in the event of breakage of the glazing unit is placed between the first substrate and the second substrate and/or between the second substrate and the third substrate and/or forms part of the third substrate.

### CROSS-REFERENCE TO RELATED APPLICATION

The present application is the U.S. counterpart of WO 03/024649, and claims priority of French Application No. 01/11902 filed on Sep. 14, 2001, the entire contents of each of which are hereby incorporated herein by reference.

The present invention relates to glazing units having a dual feature:
on the one hand, it involves glazing units known as safety glazing units, in the sense that they are capable of retaining splinters (especially glass splinters) in the event of breakage. It especially involves glazing units according to European standard ECE R43 or American standard ANSI Z26.1. These glazing units preferably successfully pass both tests described in these standards by the terms “ball drop” and “phantom drop”. The more standard configuration of this type of glazing unit is that of standard laminated glazing units, consisting of two essentially transparent rigid substrates (usually made of glass) between which at least one thermoplastic polymer sheet is placed, which will ensure the retention of glass splinters if need be. In a known manner, the lamination generally requires heating, generally under pressure, of the three assembled elements, so as to soften and make adherent the thermoplastic sheet and possibly to remove the residual air between the various elements of the glazing unit.

It may also involve laminated glazing units where the intermediate sheet is based on a single- or double-sided adhesive polymer of the elastomer type, which avoids the hot lamination operation mentioned above.

The invention also includes laminated glazing units called “asymmetrical” units, using a single rigid substrate of glass type combined with several polymer sheets, of which generally at least one is based on polyurethane (as described, for example, in patents EP 132 198, EP 131 523 and EP 389 354).

It also includes safety glazing units where the function of retaining splinters is obtained by a plastic film, especially the superposition of a polyvinyl butyral-type thermoplastic sheet and of a protective polymer sheet of the polyethylene terephthalate PET type, which is made to adhere to a rigid glass-type substrate. This type of plastic film is, for example, marketed by DuPont de Nemours under the name “Spalled Shield” or under other commercial names by “3M” or by “Southwall”. This polymer sheet may possibly be transparent to electromagnetic waves. This is the same for the product marketed by 3M which is an assembly of a complex of at least two thermoplastic sheets f′1 and f″1, it being possible for the natures and the thicknesses of each of these sheets to be different depending on the sought applications.
on the other hand, the glazing units according to the invention are “functional”, in the sense that they have at least one functionality conferred by one or more thin layers and/or one or more discontinuous elements which may be of organic, mineral or organo-mineral hybrid nature (these layers or elements generally being placed against one of the rigid substrates of the glazing units according to the invention). They will be denoted hereinafter by the term “active system(s)”. The glazing units according to the invention may comprise one or more thereof.

The first types of active system benefiting the invention are electrochemical systems in general, and more particularly, electrically controllable systems of the glazing unit type with variable optical and/or energy properties.

In particular, electrically controllable systems make it possible to obtain glazing units the darkening/degree of vision or of filtration of the thermal/solar radiation of which can be modified at will. For example, it involves viologen glazing units, which make it possible to adjust the light transmission or absorption, like the ones described in patent U.S. Pat. No. 5,239,406.

Electroluminescent systems directly convert the electrical energy into light, one example being described in patent FR-2 770 222.

There are also electrochromic glazing units, which make it possible to alter the light and heat transmission. They are especially described in patents EP-253 713 and EP-670 346, the electrolyte being in the form of a polymer or a gel and the other layers being of mineral type. Another type is described in patents EP-867 752, EP-831 360, PCT/FR00/00675 and WO 00/03289, the electrolyte being on this occasion in the form of a mainly mineral layer, all the layers of the system then mainly being mineral: this type of electrochromic system is commonly denoted by the term “all-solid” electrochromic system. There are also electrochromic systems where all the layers are of polymer type, then referred to as an “all-polymer” electrochromic system.

In general, electrochromic systems comprise two layers of electrochromic material separated by an electrolyte layer and surrounded by two electrically conducting layers.

There are also systems called “optical valves”: they involve polymer-based films in which microdroplets containing particles capable of aligning in a favored direction under the action of an electrical field are placed. One example thereof is described in patent WO 93/09460.

There are also liquid crystal systems, with an operating mode similar to the aforementioned: they use a polymer film placed between two conducting layers and in which droplets of liquid crystals, especially nematic crystals with a positive dielectric anisotropy, are dispersed. When a voltage is applied to the film, the liquid crystals are oriented along a favored axis, which allows vision. With no voltage, the film becomes diffusing. Examples thereof are described in patents EP-88 126, EP-268 877, EP-238 164, EP-357 234, EP-409 442 and EP-964 288. Mention may also be made of cholesteric liquid crystal polymers, like those described in patent WO 92/19695 and liquid crystal systems which switch with a variation in light transmission TL.

A second type of active system benefiting the invention relates to layers or stacks of layers the properties of which alter without an electrical power supply, under the effect of heat or light: mention may be made of thermochromic layers, especially vanadium oxide-based layers (one example thereof is given in the French patent filed on May 23, 2000 with application number FR 00/06585), thermotropic layers and photochromic layers.

Photovoltaic systems, which convert light energy into electrical energy, may also be involved.

Within the scope of the present invention and throughout the present text, the term “layer” must be understood in its broadest sense: it may equally well involve minerals as organic-type materials, most particularly polymers, which may be in the form of polymer films or even gel films. This is especially the case for thermotropic gels, for example those described in patents EP-639 450, U.S. Pat. No. 5,615,040, WO 94/20294 and EP-878 296.

A third type of active system benefiting the invention relates to the layers or stacks of layers with low-emissivity solar control properties, especially based on one or more silver layers interleaved by dielectric layers. These stacks may be deposited on one of the rigid substrates or be deposited on a flexible substrate of the PET (polyethylene terephthalate) type that is placed between two sheets made of a thermoplastic polymer of the PVB (polyvinyl butyral) type used to assemble the two rigid substrates of the glass type. Examples thereof are found in patents EP-638 528, EP-718 250, EP-724 955, EP-758 583 and EP-847 965.

Finally, mention may also be made of coatings with an acoustic function (acoustic attenuation), and with an optical function (decorative, absorbent, etc).

The design of glazing units having the dual feature described above is not simple, since combining an active system with polymer sheets having a splinter-retaining function in a glazing unit creates additional stresses. Thus, if an active system is inserted, for example an electrochromic system, in a conventional laminated glazing unit between the glass and the interleaved polymer film, the adherence of the polymer film to the glass tends to be decreased. There is therefore an increased risk that, should the glazing unit break, the great majority of the glass splinters can no longer be retained by the polymer film, as required by the standard.

To guard against this, if the active system is placed on one of the outer faces of a standard laminated glazing unit, it is then necessary to provide means for protecting it from contact with the surrounding atmosphere, in order to protect it from chemical or mechanical damage. This then requires the use of an additional protective substrate. Now, a certain number of applications require a nominal thickness for the glazing unit, and it is not always possible to propose glazing units that are too thick. It is especially the case for sunroofs, where car-body builders generally fit laminated or tempered glass, whose overall thickness cannot exceed about 5 mm. This is also the case for roof glazing units for example, where the frame only allows the mounting of glazing units of a predefined thickness that is often imposed by the thermal insulation performance to be achieved.

The aim of the invention is therefore to provide a new type of glazing unit which is able to reconcile compliance with safety standards with the presence of at least one of the active systems described above within the glazing unit. More particularly, it also aims to design such a glazing unit which, in addition, cannot be significantly penalized in terms of overall size when compared with a comparable standard safety glazing unit. This last point is clearly an asset when aiming for the spare parts market.

First of all, the subject of the invention is a glazing unit, successively comprising:
a first rigid substrate S1,
a second rigid substrate S2,
a third rigid, semi-rigid or flexible substrate S3,
at least one “active” system A comprising at least one layer and placed between the substrates S1 and S2 or between the substrates S2 and S3,
the third substrate S3 being set back with respect to the other two substrates S1 and S2,
a polymer film having the function of retaining splinters in the event of breakage of the glazing unit being placed between the substrate S1 and the substrate S2 and/or between the substrate S2 and the substrate S3 and/or forming part of the substrate S3.

The invention therefore focuses on a type of glazing unit making it possible to reconcile safety, functionality and sizing.

The glazing comprises the polymer film having a splinter-retaining function which is essential for obtaining the desired safety level in the event of breakage of the glazing unit. Its positioning in the glazing unit may then be selected depending on that of the active system which functionalizes the glazing unit: if the active system is between the substrate S1 and the substrate S2, the polymer film in question will preferably be between the substrate S2 and the substrate S3, or will be part of the substrate S3. On the other hand, if the active system is between the substrate S2 and the substrate S3, the polymer film in question will preferably be between the substrate S1 and S2. Advantageously, direct contact between the active system and the polymer film intended to retain most of the splinters can also be avoided. Thus, it is ensured that the presence of the active system in the glazing unit does not interfere with the adherability of the polymer film to its rigid carrier substrate or substrates of the glass type.

Of course, this does not exclude the presence of a second polymer film having a splinter-retaining function and in contact with the active system: this other film may contribute to the safety of the glazing unit, but this role is mainly dedicated to the film which is not in contact with the active system. Thus, by physically separating the splinter-retaining film and the active system, they are made to coexist in the glazing unit without one undermining the functionality of the other. However, the price for this solution is that the glazing unit contains three substrates rather than two. More particularly where it involves three rigid glass substrates, it is clear that this leads to a glazing unit which overall is thicker than a standard two-pane laminated glazing unit. It is for this reason that the invention proposes that the substrate S3 is set back from the other two: by having a smaller size, it thus leaves a peripheral region free on the perimeter of the substrate S2. If this glazing unit has to be inserted into a frame, in bodywork (some configurations will be detailed hereinafter), this will take place as if the glazing unit had only two rigid substrates S1 and S2: it will be possible to mount the glazing unit while holding it, by fastening it only over the periphery of these two substrates. The third set-back substrate will be held against the previous ones by the usual techniques detailed below (lamination, use of an adhesive), and there will be no need for the method of fastening the glazing unit to clasp it over its periphery as well. This point is most particularly advantageous when the glazing unit is intended to be a sunroof, where generally a peripheral mounting is provided for tempered monolithic glazing units or laminations not thicker than 4 or 5 mm (these standard thickness ranges being used for glazing units without an “active system” in the sense of the invention, that are generally single pane).

The glazing unit according to the invention, even in its three-pane configuration, is capable of being mounted without any problem as a standard sunroof in a vehicle body, by virtue of this particular sizing of the third pane. Even where S3 is a substrate formed from one or more superimposed polymer films (such as the PET/PVB film mentioned in the preamble), their thickness is not negligible. Furthermore, the fact that S3 is made of plastic and not of glass may present problems of mounting/peripheral sealing compared to standard two-pane laminated glazing units. Here again, the fact that S3 is smaller makes it possible, as need be, to preserve the mounting/the method of placing the usual peripheral seal of the laminated windows.

The invention is therefore very flexible in its implementation, depending on the envisioned application, of standard products whether or not it has to come close in terms of thickness or of type of material/sealing or peripheral fastening.

The active system according to the invention may be of electrically controllable type, with variable energy and/or optical properties of the electrochromic system, optical valve, viologen system, liquid crystal system, electroluminescent system type. Details concerning them have been given in the preamble of the present application.

The active system according to the invention may also be without an electrical supply, for example having a thermal function (low emissivity, solar protection), an acoustic function (acoustic attenuation) or an optical function (decorative, absorbent, etc). It may also involve thermochromic or thermotropic coatings, as was mentioned in the preamble of this present application (note that thermochromic layers may also optionally be supplied with current, so that they may be deliberately heated by resistance heating and change optical/thermal properties as desired, and not just as dictated by the ambient sunshine).

According to one variant of the invention, the substrates S1 and S2 are made of glass. As for the substrate S3, this may also be made of glass or of a polymer-based material. This polymer may be in the form of a relatively rigid substrate, of the polycarbonate PC or polymethyl methacrylate PMMA type. This material is then substituted for the glass, if for example it is sought to lighten the glazing unit as a whole. This material may also be semi-rigid or flexible, and it may form the film capable of retaining splinters in the event of breakage, as mentioned above.

According to one variant of the invention, the glazing unit according to the invention comprises at least one thermoplastic polymer sheet, having the function of retaining splinters in the event of breakage of the glazing unit, between the substrates S1 and S2 and/or between the substrates S2 and S3 (this last scenario, when S3 is a rigid substrate). If there are several sheets (or superposition of sheets) of thermoplastic polymer, it is therefore the one which is not in contact with the active system of the electrochromic type which will play the essential safety role.

According to a preferred example of the invention, the three substrates S1, S2, S3 are made of glass and laminated to each other by thermoplastic polymer sheets.

If the faces of the panes are renumbered from the outside toward the inside (by considering the glazing unit once it is mounted in the automobile or in the building), it is possible to have, for example, an active system of the electrochromic type on faces 3, 4 or 5 of panes S1, S2 or S3 depending on the case, and it is the thermoplastic inserted sheet with which it is not in contact which confers safety on the glazing unit.

Returning to the previous configuration where the substrate S3 is a film or a superposition of polymer films, it may adhere to the substrate S2 on a face which may or may not be provided with an active system according to the invention, directly or via an adhesive.

The active system A may be on the outer 3 or inner 4 face of the substrate S2 or on the outer face 5 of the substrate S3, using the convention for numbering faces mentioned above.

Advantageously, the total thickness (e1+e2) of the substrates S1 and S2 and of all the other materials likely to be placed between them (thermoplastic sheets, elastomer sheet, active system, etc.) is less than or equal to 8 mm, especially less than or equal to 5.5 mm, preferably between 2 mm and 5 mm. These thicknesses accommodate the majority of requirements if the glazing unit is for equipping a vehicle of the car type, or if it involves glazing units for a building of the roof glazing unit type.

Preferably, the substrates S1 and S2 are of substantially identical dimensions and the substrate S3 is of smaller dimensions and positioned with respect to the substrate S2 so as to delimit an open peripheral groove having a depth p of at least 5 mm, especially at least 8 mm, preferably between 10 and 25 mm. Advantageously, this groove is of constant depth over the entire perimeter of the substrates S2 and S3 delimiting it: thus, S3 is preferably centered with respect to S2, S3 having an outline identical to S2, but of smaller proportions.

With regard to the size of the active system A, its active surface is preferably of dimensions similar to or less than those of the third substrate S3. The term “active surface” refers to the surface which effectively has the desired functionality, in particular excluding the peripheral inactive regions used for the connections. If the active system is one of the faces of the substrate S3, this dimensioning is compulsory. If however it is on one face of the substrate S1 or S2, this dimensioning makes it possible for the active system to be better matched to the central region of the glazing unit which will effectively be exposed to view, and not the peripheral region of the substrates S1 and S2 which go beyond the substrate S3 and which, for esthetic reasons, will therefore generally be masked.

According to an advantageous variant of the invention, provision is made for the glazing unit to be fitted effectively with an opacifying peripheral coating, of the screen-printing type, especially on the periphery of the inner face 2 of the substrate S1 and/or on the periphery of the outer 3 or inner 4 face of the substrate S3, still using the same conventions. It may involve enamel-based coatings, which are moreover well known for automobile glazing units: these coatings may have several functions: hiding the connections of the electrically controllable active system, hiding the peripheral region of the glazing unit where the substrate S3 is absent, hiding a nontransparent function (electroluminescent system), having a decorative function, etc.

The half-open peripheral groove mentioned above and created in the glazing unit because of the setting-back of the substrate S3 may be used in different ways, and be exploited in a very advantageous manner. Of course, it will make it possible to fasten the glazing unit to its frame just by fastening substrates S1 and S2. But this free space may also make it possible, for example, for elements connecting the active system to pass therethrough, when the latter is electrically controllable.

The particular configuration of the glazing unit according to the invention makes it possible for different positionings of the peripheral seals where they are necessary. This is especially the case where the glazing unit contains active systems which are (very) sensitive to moisture, and to contact with the surrounding atmosphere in general. The position of the seal is then conditioned by that of the active system, the aim being that it is correctly sealed. Thus, if the active system is between the substrate S2 and the substrate S3, at least one seal will be useful on the periphery of S2 and S3, but not necessarily between S1 and S2. Provision may be made for several seals which are complementary in their function (one, a barrier against water vapor, the other against liquid water, for example). At least one seal is preferably provided on the edge of the substrate S1 and/or of the substrate S2, and/or that of the substrate S3, especially between S2 and S3 as seen above if the active system is between the substrate S2 and S3: either only on the edges of the two substrates and therebetween, or going beyond the face of these two substrates (or of one of them). Preferably, it involves the face which is away from the one turned toward the active system.

Various techniques may be used in order to make this peripheral seal or these peripheral seals. They can be attached, using premanufactured seals in the form of a bead (which are placed by softening them, by slight heating, for example, so that they may create the leaktightness sought on the edges of the substrates in question). They may also be extruded, the technique for extruding seals already being used in particular to make windscreen seals, as is described in patents EP 479 677 and EP 524 060.

They can also be made by an encapsulation technique. This generally involves a technique denoted by the term RIM (Reactive Injection Molding), where a polymer, which is generally polyurethane at low pressure and at a not very high temperature, is injected into a closed mold closely following the storyteller of the glazing unit (substrates S1, S2 and possibly S2 for the glazing unit of the invention). This technique is especially described in patent FR00/012398 filed on Sep. 29, 2000.

Advantageously, the peripheral seal used (or at least one of them) is flush with the outer face 1 of the first substrate S1. This type of mounting is particularly esthetic, since it provides a continuity of surface with the bodywork and the frame surrounding the glazing unit. The peripheral seal(s) may advantageously fill, at least in part, the half-open peripheral groove described above. It may also be traversed by elements for connecting the active system A if it is electrically controllable. It may also contain mechanical strengthening elements (mounts, balls, frame, etc), as is especially described in patent FR 00/13307 filed on Oct. 18, 2000 and relating to seals.

The subject of the invention is, more particularly, the embodiment where the glazing unit is a triple glazing unit, with three panes S1, S2, S3 and double lamination, fitted with an all-solid electrochromic system preferably placed on the outer face 3 of the second substrate S2: it is then the thermoplastic sheet between the substrates S2 and S3 which mainly assumes the safety function (splinter retention in the event of breakage).

The subject of the invention is all the applications of the glazing units described above, especially for the building as roof glazing or for the automotive industry as a sunroof (opening or nonopening).

The subject of the invention is also the automobile equipped in this way, preferably with the glazing unit(s) according to the invention being flush with the bodywork.

The invention will now be described in detail with the aid of nonlimiting examples illustrated by the following figures:

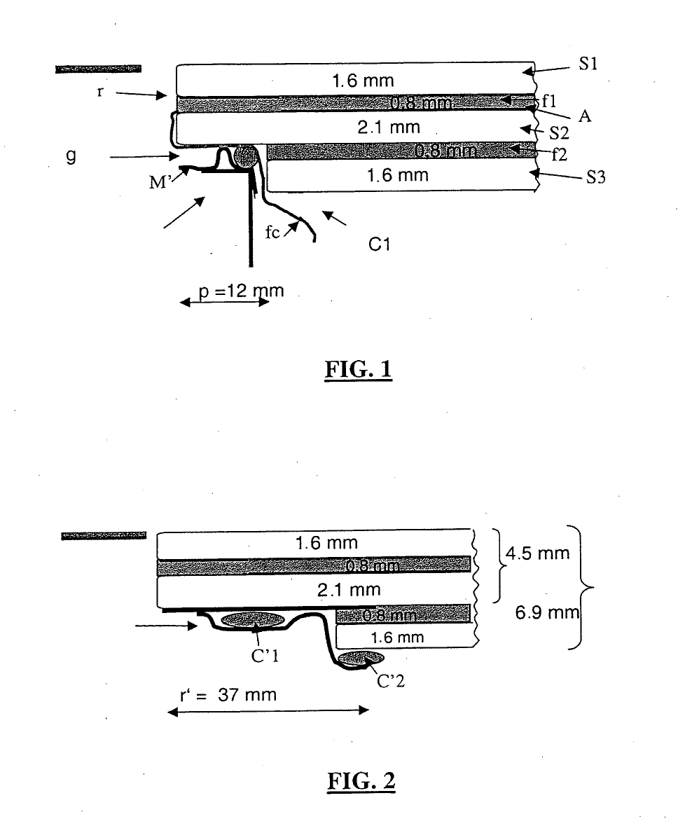

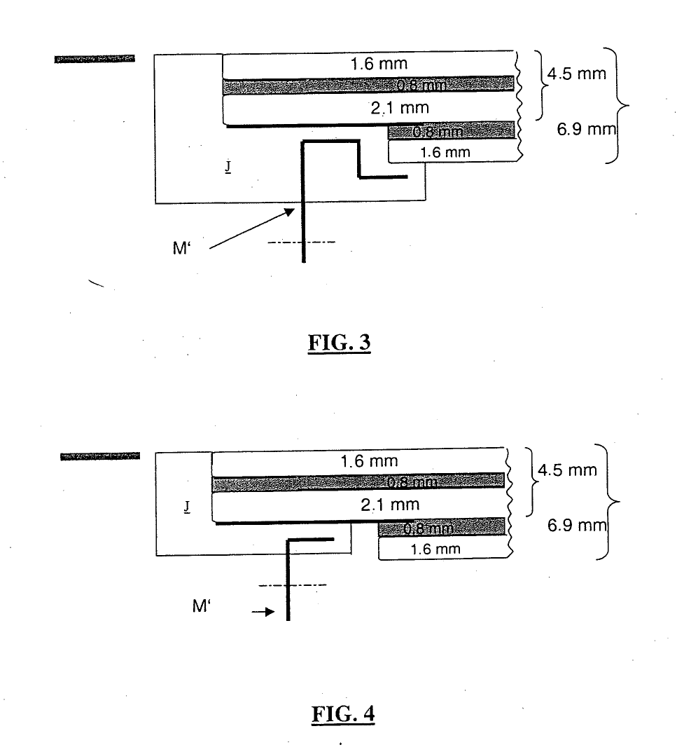

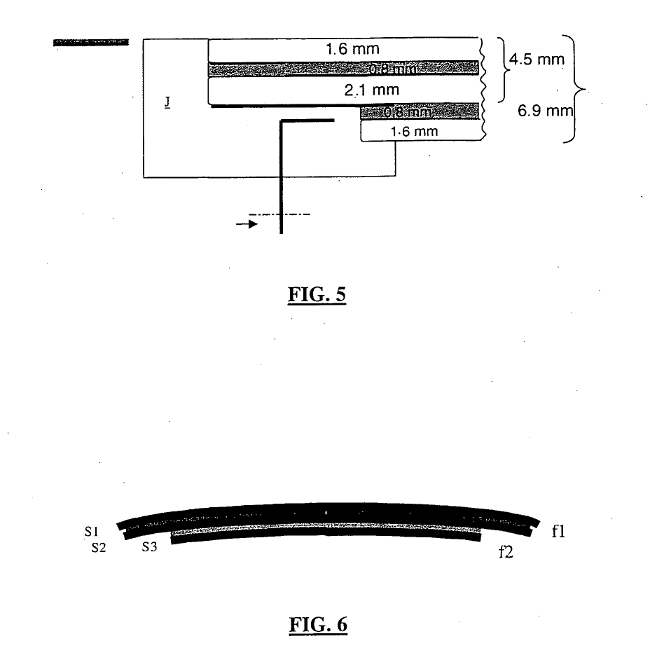

FIGS. 1 to 5: part of a glazing unit according to the invention seen in section, according to five different variants.

FIG. 6: a glazing unit according to the invention, in section, seen as a whole.

The figures are deliberately very schematic and are not necessarily to scale, in order to facilitate their reading.

### EXAMPLES 1 to 5

The following examples 1 to 5, illustrated respectively by FIGS. 1 to 5, all relate to an automobile roof glazing unit. It comprises successively, from the outside toward the inside of the passenger compartment, three panes S1, S2, S3, which are clear (they may also be tinted) silica-soda-lime panes having a thickness of 1.6, 2.1 and 1.6 mm, respectively.

FIG. 6 shows the most important feature of the glazing unit according to the invention: the panes S3 is smaller than the other two panes S1 and S2 and set back from them.

The panes S1 and S2 have the same size and the same rectangular shape. Their dimensions are 900×500 mm².

The pane S1 may have, on face 2, a stack of thin layers with a sun protection function.

The pane S3 is smaller than the other two, centered with respect to S2 and having dimensions 875×475 mm².

This configuration leaves an open peripheral groove g of variable depth p depending on the examples.

The pane S1 is laminated to the pane S2 by a thermoplastic sheet f1 made of polyurethane (PU) having a thickness of 0.8 mm (it may be replaced by a sheet of ethylene vinyl acetate (EVA) or of polyvinyl butyral (PVB).

An active system A is placed on the face 3 of the glazing unit, that is to say the outermost face of the pane S2. The active system is an all-solid electrochromic system, consisting of the stack of the following layers (starting from face 3 of the pane S2):
a lower conducting layer 2, which is a bilayer consisting of a first 30 nm SiOₓN_{y} layer surmounted by a second 250 nm ITO (tin-doped indium oxide) layer,
a second layer of anodic electrochromic material made of 40 to 100 nm of (hydrated) iridium oxide or 40 nm to 400 nm of hydrated nickel oxide, which layer may or may not be alloyed with other metals,
a layer consisting of 100 nm of tungsten oxide,
a second layer consisting of 100 nm of hydrated tantalum oxide or of hydrated silica oxide or of hydrated zirconium oxide,
a second layer of cathodic electrochromic material, based on 370 nm of tungsten oxide WO₃,
a top conducting layer consisting of 100 to 300 nm of ITO.

All these layers are deposited in a known manner by magnetic-field enhanced reactive sputtering.

The connections and all the means used to supply the two electrically conducting layers with electricity will not be detailed. It is conventional and described in the patents mentioned in the preamble.

In particular, it may include a network of conducting wires in contact with the top electrode, as described in patent PCT/FR00/00675.

The pane S2 and the pane S3 are laminated by a thermoplastic sheet f2 made of PU or EVA or PVB with a thickness of 0.38 to 0.76 mm.

The presence of the electrochromic system A on face 3 weakens the interface between the pane S2 and the thermoplastic sheet f1, which is no longer enough to guarantee the retention of splinters by the sheet f1 in the event of breakage: according to the invention, the thermoplastic sheet f2 will take over from the sheet f1 in this safety function. Reciprocally, if the active system is on face 4 or 5, it is again the sheet f1 which will predominantly take on this function.

It is also possible to have an alternative configuration, where the safety function is provided by a standard laminated glazing unit (S1+f1+S2) which is made functional by adding, by lamination with the sheet f2, a pane S3 fitted with an active system A, thereto.

Of course, as mentioned above in the present text, the active system A can be combined with its counter-substrate (as opposed to its carrier substrate, the one on which it is deposited) not by lamination, but by combination with a polymer sheet of the elastomer type, by a single- or double-sided adhesive, etc.

### Example 1

FIG. 1 shows in section a portion of the three-pane glazing unit described above, in position as an sunroof with respect to its fastening system in the bodywork. It can be seen that the groove g has a depth p of 12 mm, and that the inner face 2 of the substrate S1 is fitted over its periphery with a screen-printed opacifying coating r over a width approximately equal to the depth p of the groove g. The active system A (its active surface) has dimensions slightly less than those of the substrate S3.

The figure shows the metal frame M to which the sunroof has to be fastened, with strengtheners in the form of metal inserts M which are to be adhesively bonded to the glazing unit via a bead of adhesive C1. Conducting wires fc, which are part of the connections for the electrochromic system A, and which then traverse the groove g, can be seen passing through along the edge of the glass S2: it has proved to be very practical to use this groove to make conducting wires pass from the outside toward the inside of the glazing unit (and of the passenger compartment).

### Example 2

This refers to FIG. 2. Compared with FIG. 1, it can be seen that the setting-back of the pane S3 is larger: here, the groove has a depth p of 37 mm. There is also a screen-printed coating r′ on the face 2 of the pane S1 which is also wider than the coating r in example 1, and which is about 37 mm, the same as the depth of the groove.

The mechanical bond with the frame is now also provided on face 6 of the pane S3, with metal reinforcements M fastened to the faces 4 and 6 by means of two beads of adhesive C′1 and C′2.

### Example 3

Here again is the configuration of example 2 with regard to the 37 mm set-back of the pane S3. Here, an encapsulated seat J has been used, flush with the face 1 of the PU-based pane S1 and embedding the groove g (and in fact all the connections which pass therethrough).

This seat also contains metal reinforcements M′ and goes beyond the inner face 6 of the pane S3 for a thickness of about 2 mm. The shape of the reinforcements has been adapted so that they are more effective and that they combine the pane S3 at the mechanical bond of the glazing unit to the metal frame.

### Example 4

Here again is the configuration of examples 2 and 3. The seat J is encapsulated as in example 3, but here it is not in contact with the pane S3, neither on one of its faces nor on its edge. Here, the seat does not entirely fill the groove.

### Example 5

Here again is the configuration of example 3, but this time with more standard metal reinforcements M′.

In conclusion, the invention has developed a glazing unit where it is possible to obtain 100% of the quality expected from the active system that it contains and 100% of the safety function in particular required in the automotive industry, with a smaller overall size. If the examples are taken, it can in fact be seen that the glazing unit can be fastened to the bodywork on the panes S1 and S2, or over an overall thickness of 4.5 mm.

Many other variants are possible: in particular, it is possible to substitute the thermoplastic sheet f2 and the pane S3 with a substrate S′3 solely based on polymer sheets, which may if need be provide the required safety function. In this case, even though the substrate S3 can be relatively thin (more so than a pane), it remains of benefit to set it back with respect to the panes S1 and S2 for two alternative or cumulative reasons:
on the one hand, its thickness may not be negligible (1 mm for example),
on the other hand, if it is made of plastic while the other two substrates are made of glass, it may be beneficial to be able to continue to use:
seats which are known for property adhering to the glass for panes S1, S2 and the materials deposited between these two panes, by leaving “aside” the plastic substrate S3, the adherence of which to said seat may be judged insufficient (or the seal deposition technique of which is more suitable to glass than to thin plastic substrates),
the priming and encapsulation materials which are more suitable, in the same way, for the glass.

By way of these variants, a glazing unit can be envisioned incorporating, either between the substrates (S1 and S2) or between the substrates (S2 and S3) an active electroluminescent system of the organic type commonly called an OLED (Organic Light Emitting Diode) or PLED (Polymer Light Emitting Diode) system or of inorganic type and, in this case, commonly called a TFEL (Thin Film Electroluminescent) system.

The glazing unit may also consist of the assembly of a glass or polymer substrate S3 which is attached by adhesive bonding to a traditional glazing unit consisting of two substrates (S1+S2), the substrate S3 being smaller than S1+S2 and set back from the latter and able to include a functionality which is not detrimental to the splinter-retaining function (for example a decorative or low emissivity function or the like). An active system of electrochromic type is inserted, during the manufacture of the above glazing unit, between S3 on the one hand, and S1+S2 on the other hand.

As a variant of the preceding example, the substrate S2 is a polymer substrate with a low-emissivity function and possibly completed with a functionality of transparency to electromagnetic waves, S1 is a back pane, S3 is still set back from S1+S2 and an active system of electrochromic type is inserted between S3 and S1+S2.

1-24. (Canceled).

25. A glazing unit successively comprising:
a first rigid substrate;
a second rigid substrate;
a third rigid, semi-rigid or flexible substrate, the third substrate being set back with respect to the first and second substrates,
at least one active system comprising at least one layer and placed between the first and second substrates or between the second and third substrates; and
at least one polymer film having a function of retaining splinters in event of breakage of the glazing unit and placed between the first substrate and the second substrate and/or between the second substrate and the first substrate and/or forming part of the third substrate.

26. The glazing unit as claimed in claim 25, wherein the active system includes an electrically controllable system, with variable energy and/or optical properties of an electrochromic system, optical valve, viologen system, liquid crystal system, or electroluminescent system type.

27. The glazing unit as claimed in claim 25, wherein the active system includes a thin layer or a stack of thin layers having a thermal function of low-emissivity or solar-protection type, having an acoustic function, of acoustic attenuation coating type, having an optical function of decorative or absorbent, thermochromic, or thermotropic type.

28. The glazing unit as claimed in claim 25, wherein the first and second substrates are made of glass and the third substrate is either made of glass or of a polymer-based material.

29. The glazing unit as claimed in claim 25, further comprising at least one thermoplastic polymer sheet, having a function of retaining splinters in event of breakage of the glazing unit, provided between the first and second substrates and/or between the second and third substrates.

30. The glazing unit as claimed in claim 25, wherein the first, second, and third substrates are made of glass and are laminated to each other by thermoplastic polymer sheets.

31. The glazing unit as claimed in claim 25, wherein the first and second substrates are made of glass, and the third substrate is a polymer film or a combination of polymer films having the function of retaining splinters.

32. The glazing unit as claimed in claim 25, wherein the third substrate is a polymer film or a combination of polymer films adhering to the second substrate on its face that may or may not be equipped with the functional system, directly or by an adhesive.

33. The glazing unit as claimed in claim 25, wherein the active system is provided on an outer or inner face of the second substrate or on an outer face of the third substrate.

34. The glazing unit as claimed in claim 25, wherein a total thickness of the first and second substrates and of all other materials placed between the first and second substrates is less than or equal to 8 mm, especially less than or equal to 5.5 mm, preferably between 2 mm and 5 mm.

35. The glazing unit as claimed in claim 25, wherein the first and second substrates are of substantially identical dimensions and the third substrate is of smaller dimensions and positioned with respect to the second substrate to delimit an open peripheral groove having a depth of at least 5 mm, especially at least 8 mm, preferably between 10 and 25 mm.

36. The glazing unit as claimed in claim 35, wherein the depth of the groove is constant over an entire perimeter of the second and third substrates that delimit the groove.

37. The glazing unit as claimed in claim 25, wherein the active surface of the active system is of similar or smaller dimensions than an active surface of the third substrate.

38. The glazing unit as claimed in claim 25, further comprising an opacifying peripheral coating, of screen-printing type, on a periphery of an inner face of the first substrate and/or on a periphery of an outer or inner face of the second substrate.

39. The glazing unit as claimed in claim 25, wherein the setting back of the third substrate from the first and second substrates delimits an open peripheral groove in which connector elements of the active system run, where the active system can be electrically controlled.

40. The glazing unit as claimed in claim 25, further comprising at least one peripheral seal in contract with at least a side of the first substrate, and/or the second substrate and/or the third substrate.

41. The glazing unit as claimed in claim 40, wherein the at lest one peripheral seal is brought about or obtained by extrusion or obtained by encapsulation.

42. The glazing unit as claimed in claim 40, wherein the at least one peripheral seal is flush with an outer face of the first substrate.

43. The glazing unit as claimed in claim 40, wherein the at least one peripheral seal at least partially fills the open peripheral groove delimited by the setting back of the third substrate from the first and second substrates.

44. The glazing unit as claimed in claim 43, wherein the at least one peripheral seal is traversed by connection elements of the active system and/or includes at least, in part, mechanical strengthening elements.

45. The glazing unit as claimed in claim 25, wherein the glazing unit is a triple glazing unit, with three panes of the first, second, and third substrates and double lamination, equipped with an all-solid electrochromic system placed on an outer face of the second substrate.

46. The glazing unit as claimed in claim 25, wherein the glazing unit is a glazing unit for automotive industry or a glazing unit for a building.

47. The glazing unit as claimed in claim 25, wherein the glazing unit passes safety tests of ECE R43 and ANSI Z26.1 standards.

48. An automobile, equipped with the glazing unit as claimed in claim 25, preferably flush with bodywork.
